(19) United States
(12) Patent Application Publication
(10) Pub. No.: US 2025/0384860 A1
(43) Pub. Date: Dec. 18, 2025

(54) SILK COATING OF REEDS OF INSTRUMENTS

(71) Applicant: Trustees of Tufts College, MEDFORD, MA (US)

(72) Inventors: Fiorenzo G. Omenetto, Lexington, MA (US); Marcotullio Pignataro, Walpole, MA (US)

(21) Appl. No.: 19/170,910

(22) Filed: Apr. 4, 2025

Related U.S. Application Data
(63) Continuation of application No. PCT/US23/76599, filed on Oct. 11, 2023.
(60) Provisional application No. 63/379,139, filed on Oct. 11, 2022.

(51) Int. Cl. G10D 9/08; G10D 9/035

(52) U.S. Cl. CPC G10D 9/08; G10D 9/035

(57) ABSTRACT

Improved reeds for a reed blown musical instrument includes silk fibroin coating or impregnation. An example reed includes a reed body having a reed tip adapted for engagement by a mouth of a player and a vibrating part that extends from the reed tip and configured to vibrate and a silk fibroin coating of at least a portion of the reed body. Another example reed includes a reed body having a reed tip adapted for engagement by a mouth of a player and a vibrating part that extends from the reed tip and is configured to vibrate, wherein at least a portion of the reed body is impregnated with silk fibroin.

### CLAIM TO PRIORITY

This application claims benefit of and is a continuation of International Patent Application No. PCT/US2023/076599 (Attorney Docket. No. 2095.0574), filed Oct. 11, 2023, and entitled “SILK COATING OF REEDS OF INSTRUMENTS,” International Pub. No. WO2024081733, which is hereby incorporated by reference in its entirety for all purposes.

International Patent Application No. PCT/US2023/076599 claims the benefit of the following provisional applications, which is hereby incorporated by reference in its entirety for all purposes: U.S. Patent Application 63/379,139 (Attorney Docket. No. 2095.0424), filed Oct. 11, 2022.

### BACKGROUND

Reeds of woodwind musical instruments (e.g., saxophone, clarinet, oboe and bassoon) are traditionally manufactured from natural cane (Arundo donax L.). Coming from a natural source, the material properties can be influenced by a number of factors including the growth conditions of the plant and the storage conditions of the raw material. These variations result in the alteration of the reed's vibrational behavior which determines its playing characteristics and tone richness. Moreover, reeds are trued by the saliva amylases and conform to the musician's mouth while being played during an initial ‘breaking in’ period which is followed by the degradation of the reed.

### SUMMARY

In some aspects, the disclosure herein relates to a reed for a reed blown musical instrument, including: a reed body having a reed tip adapted for engagement by a mouth of a player and a vibrating part that extends from the reed tip and configured to vibrate; and a silk fibroin coating of at least a portion of the reed body.

In some aspects, the disclosure herein relates to a silk-coated reed for a reed blown musical instrument, including: a natural cane reed having a reed tip adapted for engagement by a mouth of a player and a vibrating part that extends from the reed tip and is configured to vibrate; and a silk fibroin coating of the natural cane reed to form the silk-coated reed, wherein the natural cane reed possesses at least one cane reed characteristic that is inferior to a corresponding reed characteristic of the silk-coated reed.

In some aspects, the disclosure herein relates to a reed for a reed blown musical instrument, including: a reed body having a reed tip adapted for engagement by a mouth of a player and a vibrating part that extends from the reed tip and is configured to vibrate; wherein at least a portion of the reed body is impregnated with an impregnated silk fibroin.

In some aspects, the techniques described herein relate to a method, including: applying a regenerated silk fibroin solution to a reed for a reed blown musical instrument on at least a portion of the reed; and drying the regenerated silk fibroin solution on the reed to form a silk fibroin coating.

In some aspects, the techniques described herein relate to a method, including: contacting at least a portion of a reed for a reed blown musical instrument with a regenerated silk fibroin solution, wherein contacting delivers the regenerated silk fibroin solution into the reed; and drying the regenerated silk fibroin solution to impregnate the reed with the regenerated silk fibroin solution.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a side view of a reed.

FIG. 2 depicts a side view of a double reed.

### DETAILED DESCRIPTION

Before the present disclosure is described in further detail, it is to be understood that the disclosure is not limited to the particular embodiments described. It is also understood that the terminology used herein is for the purpose of describing particular embodiments only, and is not intended to be limiting. The scope of the present disclosure will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, “silk fibroin” refers to silk fibroin protein whether produced by silkworm, spider, or other insect, or otherwise generated (Lucas et al., Adv. Protein Chem., 13:107-242 (1958)). Any type of silk fibroin can be used in different embodiments described herein. Silk fibroin produced by silkworms, such as Bombyx mori, is the most common and represents an earth-friendly, renewable resource. For instance, silk fibroin used in a silk film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants, and variants thereof, that can be used. See, e.g., WO 97/08315 and U.S. Pat. No. 5,245,012, each of which is incorporated herein by reference in their entireties.

Coating and impregnating reeds with a silk fibroin solution is a sustainable route to (i) increase the durability of the reeds (ii) reduce the ‘breaking in’ period (iii) provide instant playability without the need to pre-wet the reed and (iv) improve the sound quality.

The typical lifespan of a cane reed, such as those described in U.S. Pat. Nos. 10,497,343 and 11,676,562, all of which are incorporated by reference in their entirety, is short, ranging from 1 to 2 weeks for professional musicians. The silk fibroin coating can extend the lifespan on the reed by slowing down the degradation and softening processes caused by the saliva enzymes and the mechanical stress applied during playing. The coating can also be used to preserve the shape of the reed after its conformation to the musician's mouth during the ‘breaking in’ period.

The ‘breaking in’ period is the time during which the stiffness of new reeds decreases making them more responsive and improving their playing characteristics. Cane reeds are porous and absorb saliva, which causes their softening. The first time they are played, they absorb the most moisture and are prone to waterlogging. Consequently, musicians play a new reed just for few minutes on its first use and slowly increase the playing time day by day until the reed becomes stable and can be played for a longer time before becoming waterlogged. This transition period allows the reed to conform to the mouthpiece and makes it less likely to warp. Impregnating the reeds with a silk fibroin solution reduces (or eliminates) the breaking-in period since it fills the pores eliminating the risk of waterlogging during the first uses.

Cane reeds need to be pre-wetted (conditioned) before every use as the pores must be partially filled to have good playability. Impregnating the reeds with a silk fibroin solution fills its pores and may partially or entirely eliminate this need.

The presence of silk fibroin in the cane pores and on the reeds surface, can modify the vibrational behavior of the reed and improve the sound quality.

The variability of the raw material of natural cane reeds, their short durability and the need for break in and conditioning, urged inventors to propose solutions to these problems. U.S. Pat. Nos. 2,230,933 and 6,087,571, all of which are hereby incorporated by reference in their entirety, presented synthetic reeds made of thermoplastics such as polyethylene and polypropylene. Reeds made of such materials are commercially available and have improved durability compared to natural cane ones. However, musicians generally express a strong preference towards cane reeds as they show superior vibrational behavior. The silk fibroin coating could improve the properties of cane reeds still maintaining their excellent playability. U.S. Pat. Nos. 4,145,949, 3,705,820, 6,346,663 and 3,340,759, and US Pat. Appl. No. 2022/0355506, all of which are hereby incorporated by reference in their entirety, presented synthetic coatings (i.e., metal powder, resins and plastisol respectively) to be applied on natural cane reeds. The application of these coatings requires complex drying/curing steps (e.g., under pressure, radiation, vacuum or at high temperature) which are not needed for the silk fibroin coating. In fact, such coating can be also applied in a home setting to preserve the shape of the reed after it conformed to the musician's mouth. Furthermore, silk fibroin is a natural polymer, and, unlike synthetic reeds and coatings, does not alter the biodegradability of cane reeds.

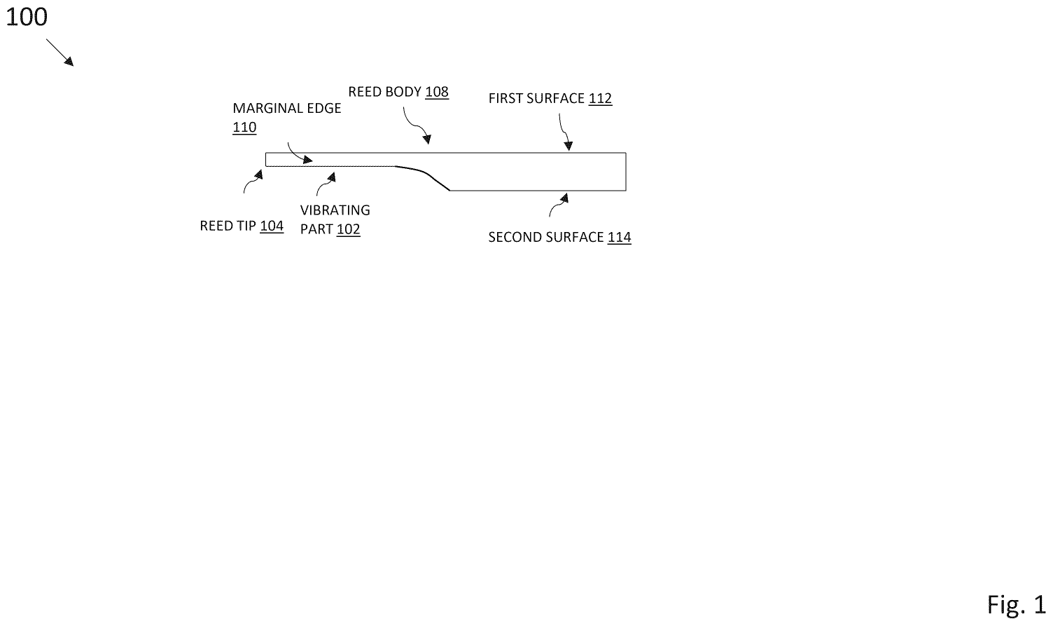

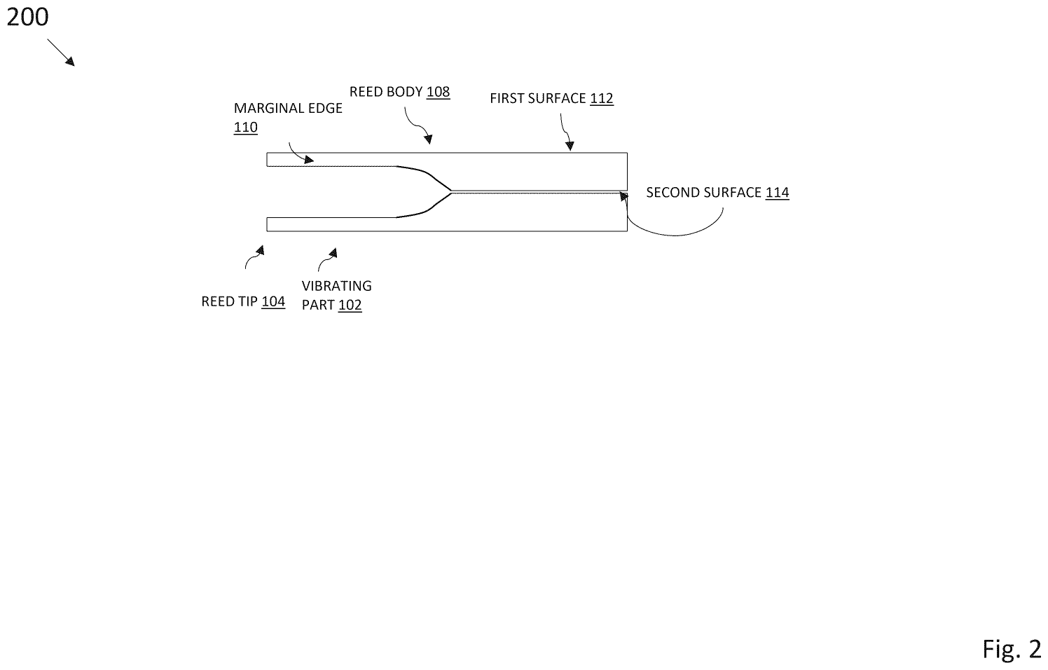

Referring now to FIG. 1, a reed 100 for a reed blown musical instrument, which may include any of the reeds throughout this disclosure, may include a reed body 108 having a reed tip 104 adapted for engagement by a mouth of a player and a vibrating part 102 that extends from the reed tip 104 and configured to vibrate. In some embodiments, the vibrating part 102 may include a portion of the reed body 108. In some embodiments, the vibrating part 102 may include the entirety of the reed body 108. It should be understood that any portion, or one or more portions, of the reed may be configured to vibrate. The reed body is configured to engage with a mouthpiece of a windblown instrument. In some embodiments, and referring now to FIG. 2, the reed may be used as one or both of the reeds in a reed-blown instrument, such as in a double reed blown instrument. The reed may be configured to vibrate against a second reed.

It should be understood that reeds of this disclosure may be of any dimension including any thickness, taper, length, width, curvature, or shape, and may be for any type of single-reed or double-reed windblown instrument (e.g., the reed may be a saxophone reed, a sopranissimo saxophone reed, a sopranino saxophone reed, a soprano saxophone reed, an alto saxophone reed, a tenor saxophone reed, a baritone saxophone reed, a bass saxophone reed, a contrabass saxophone reed, a subcontrabass saxophone reed, a clarinet reed, a piccolo clarinet reed, a sopranino clarinet reed, a soprano clarinet reed, a basset clarinet reed, a basset horn reed, an alto clarinet reed, a bass clarinet reed, a contrabass clarinet reed, a soprano clarinet in A reed, a basset clarinet reed, an oboe reed, a bassoon reed, an accordion reed, or a bagpipe reed).

In some embodiments, the reed 100 may include a silk fibroin coating of one or more of at least a portion of the reed body 108, such as the reed tip 104, the vibrating part 102, at least one marginal edge section 110, at least a portion of a first surface 112, at least a portion of a second surface 114, or the entirety of the reed body 108.

In some embodiments, the reed 100 may be impregnated with a regenerated silk fibroin solution which dries to form an impregnated silk fibroin, such as of one or more of at least a portion of the reed body 108, such as the reed tip 104, the vibrating part 102, at least one marginal edge section 110, or the entirety of the reed body 108.

Regenerated silk fibroin solution is disclosed throughout this specification in various embodiments and methods, and may be used for either coating of reeds or impregnation of reeds. The regenerated silk fibroin solution may be as described in International Patent Application Pubs. No. WO 2014/145002 and WO 2014/011644, both of which are incorporated by reference herein in their entirety. The regenerated silk fibroin solution may include a silk fibroin concentration by weight within a range of 0.1% to 50%, or within a range of 1% to 5%. The regenerated silk fibroin solution may include silk fibroin having an average molecular weight in a range between 3.5 kDa and 200 kDa. The regenerated silk fibroin solution may further include at least one of a flavorant, a colorant, or a functionalizing agent. The regenerated silk fibroin solution may be prepared by a process that includes boiling for a period of time within a range of 1 minute to and 120 minutes. In some embodiments, boiling may be at an atmospheric boiling pressure. In some embodiments, boiling may be at a temperature within a range of 30° C. and 120° C.

In an aspect, the silk fibroin coating may be applied after conformation to a mouth of a player. The silk fibroin coating may fill a plurality of pores of the reed.

In an aspect, the reed is impregnated with the regenerated silk fibroin solution after conformation to a mouth of a player. The regenerated silk fibroin solution may fill a plurality of pores of the reed.

Reeds with a silk fibroin coating or reeds having been impregnated with silk fibroin, hereinafter referred to collectively as silk reeds, may exhibit characteristics and/or have features that are different from reeds lacking a silk fibroin coating and/or unimpregnated reeds, hereinafter referred to collectively as non-silk reeds. For example, silk reeds may exhibit one or more of increased durability, resistance to changes with humidity/moisture, increased lifespan, reduced degradation, reduced time for break-in, eliminated break-in, reduced risk of waterlogging, reduced or eliminated need for pre-wetting, improved preservation of shape post-conformation to a mouth of a player, improved sound quality, improved responsiveness, or improved playing characteristics. Additionally, silk reeds may not have altered biodegradability relative to comparable non-silk reeds.

In an aspect, silk reeds may have a resonant frequency that is within 10%, within 5%, within 1%, or within 0.1% of a comparison resonant frequency of a comparison non-silk reed. In this example, the silk reed and the comparison non-silk reed may each be unused, may each have been played at least one time, or may each be conformed to a mouthpiece.

In as aspect, a spectral centroid of a tone played on the silk reed is at least 1%, at least 2%, at least 5%, or at least 10% higher than a comparison spectral centroid of the tone played on a comparison non-silk reed.

In an aspect, a weight of the silk reed changes by less than 1%, less than 5%, less than 10%, or less than 15% when exposed to a relative humidity of greater than 50%. The exposure may be at least 30 minutes, at least 1 hour, at least 5 hours, at least 10 hours, or at least 24 hours.

In an aspect, an elastic modulus of the silk reed changes by less than 1%, less than 5%, less than 10%, or less than 15% when exposed to a relative humidity of greater than 50%. The exposure may be at least 30 minutes, at least 1 hour, at least 5 hours, at least 10 hours, or at least 24 hours.

In an aspect, there is an increased time for silk reeds to reach a reduction of resonant frequency of at least 20%, at least 40%, at least 80%, or at least 90%.

In an aspect, the silk reed is playable for at least three times, at least twice, at least 1.75 times, at least 1.5 times, or at least 1.25 times as many hours as a comparison non-silk reed.

In an aspect, the silk reed exhibits playability at a defined resonant frequency for at least three times, at least twice, at least 1.75 times, at least 1.5 times, or at least 1.25 times as many hours as a comparison non-silk reed.

In an aspect, a break-in period of the silk reed is reduced by at least 6-fold, at least 5-fold, at least 4-fold, at least 3-fold, or at least 2-fold relative to a break-in time for a comparison non-silk reed.

In an aspect, a pre-wetting duration of the silk reed is reduced by at least 6-fold, at least 5-fold, at least 4-fold, at least 3-fold, or at least 2-fold relative to a pre-wetting duration for a comparison non-silk reed that lacks the silk fibroin coating.

In an aspect, the silk reed comprises at least one of a cane material, a natural material, a wood material, a spruce material, a coconut material, a beech material, an oak material, a flax material, a sisal material, a Miscanthus material, a hemp material, or a cellulose material.

In an aspect, the silk fibroin coating is applied at a temperature of at most 60° F., at most 65° F., at most 70° F., at most 80° F., or at most 90° F.

In an aspect, the silk fibroin coating is applied at atmospheric pressure. In some aspects, the silk fibroin coating is applied at a pressure of at most 15 psi, at most 14 psi, at most 13 psi, or at most 12 psi.

In an aspect, the impregnation of the reed proceeds at a temperature of at most 60° F., at most 65° F., at most 70° F., at most 80° F., or at most 90° F.

In an aspect, the impregnation of the reed proceeds at atmospheric pressure.

In an aspect, the impregnation of the reed proceeds at a pressure of at most 15 psi, at most 14 psi, at most 13 psi, or at most 12 psi.

In an aspect, a silk-coated reed for a reed blown musical instrument may include a natural cane reed having a reed tip adapted for engagement by a mouth of a player and a vibrating part that extends from the reed tip and is configured to vibrate, and a silk fibroin coating of the natural cane reed to form the silk-coated reed, wherein the natural cane reed possesses at least one cane reed characteristic that is inferior to a corresponding reed characteristic of the silk-coated reed. The at least one cane reed characteristic is a performance characteristic, a wettability characteristic, a durability characteristic, a flexibility characteristic, a vibratory characteristic, a tonal characteristic, or a spectral characteristic, a moisture resistance characteristic, or a break-in characteristic.

In an aspect, a method may include applying a regenerated silk fibroin solution to a reed for a reed blown musical instrument on at least a portion of the reed, and drying the regenerated silk fibroin solution on the reed to form a silk fibroin coating. Applying may include dipping the reed in the regenerated silk fibroin solution, or may include at least one of spraying, wiping, smearing, or spreading. Dipping may be of at least one of a first surface, a second surface, a marginal edge, a reed tip, or a vibrating part of the reed. In as aspect, drying may be for at least 4 hours, at least 8 hours, at least 12 hours, at least 18 hours, overnight, or at least 24 hours. In as aspect, drying may proceed at a pressure of at most 15 psi, at most 14 psi, at most 13 psi, at most 12 psi, or at atmospheric pressure. In an aspect, the reed has been conformed to a mouth of a player prior to the applying. In some aspects, the method may further include conforming the reed to a mouth of a player prior to the applying. In some aspects, the reed has a reed tip structured to be coupled to a mouthpiece of the reed blown musical instrument and a vibrating part that is free to vibrate. The reed may be configured to vibrate against a second reed.

In an aspect, a method may include contacting at least a portion of a reed for a reed blown musical instrument with a regenerated silk fibroin solution, wherein contacting delivers the regenerated silk fibroin solution into the reed, and drying the regenerated silk fibroin solution to impregnate the reed with the regenerated silk fibroin solution. Contacting may be of at least one of a marginal edge, a reed tip, or a vibrating part of the reed. In as aspect, drying may be for at least 4 hours, at least 8 hours, at least 12 hours, at least 18 hours, overnight, or at least 24 hours. In as aspect, drying may proceed at a pressure of at most 15 psi, at most 14 psi, at most 13 psi, at most 12 psi, or at atmospheric pressure. In an aspect, the reed has been conformed to a mouth of a player prior to the applying. In some aspects, the method may further include conforming the reed to a mouth of a player prior to the applying. In some aspects, the reed has a reed tip structured to be coupled to a mouthpiece of the reed blown musical instrument and a vibrating part that is free to vibrate. The reed may be configured to vibrate against a second reed.

### Example 1

A lower molecular weight silk solution was prepared, using a method that is similar to the methods described in International Patent Application Pub. No. WO 2014/145002, which is incorporated herein in its entirety by reference. Throughout the degumming process, a total boil time of 60 minutes was used to prepare an aqueous silk solution with a desired molecular weight distribution. The concentration of silk fibroin was adjusted to 1 wt % and a saxophone reed was immersed in the solution for 1 hour. The reed was then removed and dried overnight at room temperature. The result was a silk fibroin impregnated reed. Without wishing to be bound by any particular theory, it is believed that the impregnation process may also provide a coating of some degree or a complete coating.

### Example 2

A higher molecular weight silk solution was prepared, using the same method as described in Example 1, with a total boil time throughout the degumming process of 30 minutes to prepare an aqueous silk solution with a desired molecular weight distribution. The concentration of the silk fibroin was adjusted to 3 wt %. A saxophone reed was dipped into the solution, removed, and dried overnight at room temperature. The result was a silk coated reed. Without wishing to be bound by any particular theory, it is believed that the coating process may also provide a small degree of impregnation, though it is expected to produce principally a coating.

### Example 3

The coated and/or impregnated reeds prepared in Examples 1 and 2 were placed into use by a professional saxophonist, who employs a regularly rotating and regularly replaced set of saxophone reeds in their job performing music. Observationally, the musician observed no reduction in quality of tone produced when the coated and/or impregnated reeds were used. The mouth feel was consistent with the musician's expectations for a high quality performance reed. In some instances, coated reeds were observed to enhance the firmness of the reed and brighten the tonal response, while maintaining the overall sound quality generally associated with conventional reeds. During one particular trip, the musician's reeds were out of their possession due to travel logistics and were returned to them with signs of damage due to exposure to extreme conditions believed to be a significant and/or rapid change in humidity. The musician's full complement of untreated reeds was damaged beyond usability, as were reeds of other woodwind musicians whose reeds endured the same conditions, while the coated and/or impregnated reeds remained usable. It was unexpectedly discovered that coating and/or impregnating woodwind reeds with silk fibroin could have a meaningful effect on the reed's durability, while simultaneously having little to no effect on the reed's performance capability.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

1. A reed for a reed blown musical instrument, comprising:
a reed body having a reed tip adapted for engagement by a mouth of a player and a vibrating part that extends from the reed tip and configured to vibrate; and
a silk fibroin coating of at least a portion of the reed body.

2. The reed of claim 1, wherein the reed tip comprises the silk fibroin coating.

3. The reed of claim 1, wherein the vibrating part comprises the silk fibroin coating.

4. The reed of claim 1, wherein the reed body comprises at least one marginal edge section, wherein the at least one marginal edge section comprises the silk fibroin coating.

5. (canceled)

6. The reed of claim 1, wherein the reed body comprises a first surface and a second surface, wherein the first surface or the second surface comprises the silk fibroin coating.

7-8. (canceled)

9. The reed of claim 1, wherein the silk fibroin coating is formed from a regenerated silk fibroin solution.

10-16. (canceled)

17. The reed of claim 1, wherein the silk fibroin coating is applied after conformation to a mouth of a player.

18. The reed of claim 1, wherein the silk fibroin coating fills a plurality of pores of the reed.

19. The reed of claim 1, wherein the reed has a resonant frequency that is within 10% of a comparison resonant frequency of a comparison reed that lacks the silk fibroin coating.

20-22. (canceled)

23. The reed of claim 1, wherein the reed comprises at least one of increased durability, resistance to changes with humidity/moisture, increased lifespan, reduced degradation, reduced time for break-in, eliminated break-in, reduced risk of waterlogging, reduced or eliminated need for pre-wetting, improved preservation of shape post-conformation to a mouth of a player, improved sound quality, improved responsiveness, or improved playing characteristics.

24. The reed of claim 1, wherein a spectral centroid of a tone played on the reed is at least 1% higher than a comparison spectral centroid of the tone played on a comparison reed that lacks the silk fibroin coating.

25. The reed of claim 1, wherein a weight of the reed changes by less than 1% when exposed to a relative humidity of greater than 50%.

26. (canceled)

27. The reed of claim 1, wherein an elastic modulus of the reed changes by less than 1% when exposed to a relative humidity of greater than 50%.

28. (canceled)

29. The reed of claim 1, wherein the silk fibroin coating increases a time until the reed reaches a reduction of resonant frequency of at least 20%.

30. The reed of claim 1, wherein the reed is playable for at least 1.25 times as many hours as a comparison reed that lacks the silk fibroin coating.

31. The reed of claim 1, wherein the reed exhibits playability at a defined resonant frequency for or at least 1.25 times as many hours as a comparison reed that lacks the silk fibroin coating.

32-33. (canceled)

34. The reed of claim 1, wherein the reed comprises a cane material, a natural material, a wood material, a spruce material, a coconut material, a beech material, an oak material, a flax material, a sisal material, a Miscanthus material, a hemp material, a cellulose material, or a combination thereof.

35-39. (canceled)

40. The reed of claim 1, wherein the reed is a saxophone reed, a sopranissimo saxophone reed, a sopranino saxophone reed, a soprano saxophone reed, an alto saxophone reed, a tenor saxophone reed, a baritone saxophone reed, a bass saxophone reed, a contrabass saxophone reed, a subcontrabass saxophone reed, a clarinet reed, a piccolo clarinet reed, a sopranino clarinet reed, a soprano clarinet reed, a basset clarinet reed, a basset horn reed, an alto clarinet reed, a bass clarinet reed, a contrabass clarinet reed, an oboe reed, a bassoon reed, an accordion reed, a bagpipe reed, or a combination thereof.

41-57. (canceled)

58. A reed for a reed blown musical instrument, comprising:
a reed body having a reed tip adapted for engagement by a mouth of a player and a vibrating part that extends from the reed tip and is configured to vibrate;
wherein at least a portion of the reed body is impregnated with an impregnated silk fibroin.

59-108. (canceled)

109. A method, comprising:
contacting a regenerated silk fibroin solution to a reed for a reed blown musical instrument on at least a portion of the reed; and
drying the regenerated silk fibroin solution on the reed to form a silk fibroin coating.
